(19) United States
(12) Patent Application Publication
(10) Pub. No.: US 2017/0024665 A1
(43) Pub. Date: Jan. 26, 2017

(54) METHOD, APPARATUS AND COMPUTER PROGRAM PRODUCT FOR DETERMINING TAXES AND FEES FOR A TRAVEL ITINERARY

(71) Applicant: SABRE GLBL INC., Southlake, TX (US)

(72) Inventors: Grzegorz Cholewiak, Southlake, TX (US); Yanjun Zhang, Southlake, TX (US)

(21) Appl. No.: 14/807,510

(22) Filed: Jul. 23, 2015

(51) Int. Cl. G06Q 10/02; G06Q 30/04

(52) U.S. Cl. CPC G06Q 10/02; G06Q 30/04

(57) ABSTRACT

A method is provided for determining the taxes and fees for a group of itineraries itinerary in an efficient manner to reduce latency and computer processing resource requirements by determining the taxes and fees for a single itinerary that is representative of a related group of itineraries. Methods provided herein may include receiving a plurality of itineraries, where each itinerary includes an origin and a destination; determining a key for each of the plurality of itineraries; and grouping the itineraries into a plurality of groups, where itineraries with matching keys are grouped together in a single group. The method may include determining tax and fee information for each group, and assigning the determined tax and fee information for each respective group to each of the itineraries within the respective group.

### TECHNICAL FIELD

Example embodiments of the present invention relate generally to the generation of travel itineraries and their associated costs, and more particularly, to a method of determining the taxes and fees for a group of similar itineraries with certain common parameters based on a calculation using an itinerary representative of the group to reduce latency and computer processing resource requirements.

### BACKGROUND

The internet has brought about the ability to purchase almost anything online and to price shop among competitors with relative ease. One particular industry that has benefited from online shopping is the travel industry. Users can search for itineraries that meet their travel needs through a variety of travel-related web sites. Searches can be conducted for flights between airports, where dozens of results may be available in mere seconds. The available online shopping tools enable users to select between direct, one- or multi-stop flights to reach their destination based on flight schedules, airfare costs, and the user's schedule. While search results for a particular combination of origin and destination airports can be available in a matter of seconds, some searches can take substantially longer, particularly when there are many flight options or when computing resources for the search tools are heavily taxed with traffic.

### BRIEF SUMMARY

In general, example embodiments of the present invention provide an improved method for determining the taxes and fees for a particular itinerary in an efficient manner to reduce latency and computer processing resource requirements.

According to some embodiments, methods may include: receiving a plurality of itineraries, where each itinerary includes an origin and a destination; determining a key for each of the plurality of itineraries; and grouping the itineraries into a plurality of groups, where itineraries with matching keys are grouped together in a single group. The method may include determining tax and fee information for each group, and assigning the determined tax and fee information for each respective group to each of the itineraries within the respective group. Determining tax and fee information for each group may include selecting a representative itinerary from each group and determining tax and fee information for each selected representative itinerary. Methods may include generating a total cost for each of the plurality of itineraries, where generating a total cost comprises incorporating the determined tax and fee amount associated with each of the plurality of itineraries with a respective determined variable cost of each of the plurality of itineraries.

According to some embodiments, determining a key for each of the plurality of itineraries may include: establishing a code associated with the origin airport, the destination airport, and intervening airports, if any in the itinerary; establishing a code for at least one fare rule relating to at least one of the origin airport, the destination airport, or an intervening airport; and concatenating the codes associated with the origin airport, the destination airport, the intervening airport if any, and the code for at least one fare rule relating to at least one of the origin airport, the destination airport, or an intervening airport. Determining a key for each of the plurality of itineraries may include: classifying a transfer point at an intervening airport according to a layover time; establishing a code for the classified transfer point; and concatenating the codes associated with the origin airport, the destination airport, the intervening airport, the code for at least one fare rule relating to at least one of the origin airport, destination airport, or an intervening airport, and the code for the classified transfer point. Methods of determining a key for each of the plurality of itineraries may include: determining fare break information associated with any of the origin airport, the destination airport, or the intervening airport if any; establishing a code for the determined fare break information; and concatenating the codes associated with the origin airport, the destination airport, the intervening airport if any, the code for at least one fare rule relating to at least one of the origin airport, the destination airport, or an intervening airport, and the code for the determined fare break information.

Embodiments may provide an air-travel itinerary search system comprising at least one processor and at least one memory including computer program code. The at least one memory, and the computer program code may be configured to, with the at least one processor, cause the itinerary search system to: receive a plurality of itineraries, where each itinerary includes an origin and a destination; determine a key for each of the plurality of itineraries; group itineraries into a plurality of groups, wherein itineraries with matching keys are grouped together into a single group; determine tax and fee information for each group; and assign the determined tax and fee information for each respective group to each of the itineraries within the respective group. Causing the system to determine tax and fee information for each group may include causing the system to select a representative itinerary from each group and determine tax and fee information for each selected representative itinerary. Embodiments of the system may further be caused to generate a total cost for each of the plurality of itineraries, where causing the system to generate a total cost for each of the plurality of itineraries includes causing the system to incorporate the determined tax and fee amount associated with each of the plurality of itineraries with a respective determined variable cost of each of the plurality of itineraries.

According to some embodiments, causing the system to determine a key for each of the plurality of itineraries may include causing the system to: establish a code associated with the origin airport, the destination airport, and intervening airports, if any, in the air-travel itinerary; establish a code for at least one fare rule relating to at least one of the origin airport, the destination airport, or an intervening airport; and concatenate the codes associated with the origin airport, the destination airport, the intervening airport if any, and the code for at least one fare rule relating to at least one of the origin airport, the destination airport, or an intervening airport. Causing the system to determine a key for each of the plurality of itineraries may further include causing the system to classify a transfer point at an intervening airport according to a layover time; establish a code for the classified transfer point; and concatenate the codes associated with the origin airport, the destination airport, the intervening airport, the code for at least one fare rule relating to at least one of the origin airport, the destination airport, or an intervening airport, and the code for the classified transfer point. According to some embodiments, causing the system to determine a key for each of the plurality of itineraries further comprises causing the system to: determine fare break information associated with any of the origin airport, the destination airport, or the intervening airport if any; establish a code for the determined fare break information; and concatenate the codes associated with the origin airport, the destination airport, the intervening airport if any, the code for at least one fare rule relating to at least one of the origin airport, the destination airport, or an intervening airport, and the code for the determined fare break information.

Embodiments of the present invention may provide for a computer program product including at least one non-transitory computer-readable storage medium having computer-executable program code stored therein. The computer-executable program code instructions may include: program code instructions for receiving a plurality of itineraries, where each itinerary includes an origin and a destination; program code instructions for determining a key for each of the plurality of itineraries; program code instructions for grouping itineraries into a plurality of groups, wherein itineraries with matching keys are grouped together into a single group; program code instructions for determining tax and fee information for each group; and program code instructions for assigning the determined tax and fee information for each respective group to each of the itineraries within the respective group. The program code instructions for determining tax and fee information for each group may include program code instructions for selecting a representative itinerary from each group and program code instructions for determining tax and fee information for each selected representative itinerary. The computer program product of some embodiments may further include program code instructions for generating a total cost for each of the plurality of itineraries, where the program code instructions for generating a total cost each of the plurality of itineraries may include program code instructions for incorporating the determined tax and fee amount associated each of the plurality of itineraries with a respective determined variable cost of each of the plurality of itineraries.

According to some embodiments, the program code instructions for determining a key for each of the plurality of itineraries may include: program code instructions for establishing a code associated with the origin airport, the destination airport, and intervening airports, if any, in the air-travel itinerary; program code instructions for establishing a code for at least one fare rule relating to at least one of the origin airport, the destination airport, or an intervening airport; and program code instructions for concatenating the codes associated with the origin airport, the destination airport, the intervening airport if any, and the code for at least one fare rule relating to at least one of the origin airport, the destination airport, or an intervening airport. The program code instructions for determining a key for each of the plurality of itineraries may further include: program code instructions for classifying a transfer point at an intervening airport according to a layover time; program code instructions for establishing a code for the classified transfer point; and program code instructions for concatenating the codes associated with the origin airport, the destination airport, the intervening airport, the code for at least one fare rule relating to at least one of the origin airport, the destination airport, or an intervening airport, and the code for the classified transfer point

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a travel booking system and associated entities in accordance with an example embodiment of the present invention;

FIG. 2 illustrates a block diagram of a travel booking system according to an example embodiment of the present invention;

FIG. 3 depicts communication flow through various components of a travel booking system according to an example embodiment of the present invention; and

FIG. 4 is a flow chart of a method for implementing a travel booking system according to an example embodiment of the present invention.

### DETAILED DESCRIPTION

Some example embodiments of the present invention will now be described more fully hereinafter with reference to the accompanying drawings, in which some, but not all embodiments of the invention are shown. Indeed, various embodiments of the invention may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention.

Provided herein is a method for determining taxes and fees associated with a group of similar itineraries with certain common parameters based on a calculation using an itinerary representative of the group that reduces latency and computer processing resource requirements. Example embodiments may provide an accurate quotation of taxes and fees for an itinerary to promote fast response times to itinerary searches on travel booking websites. Embodiments described herein create unique identifiers for each itinerary and group together itineraries that are determined to have the same tax and fee information such that a single calculation of taxes and fees for a representative itinerary can be applied to each of the itineraries in the group.

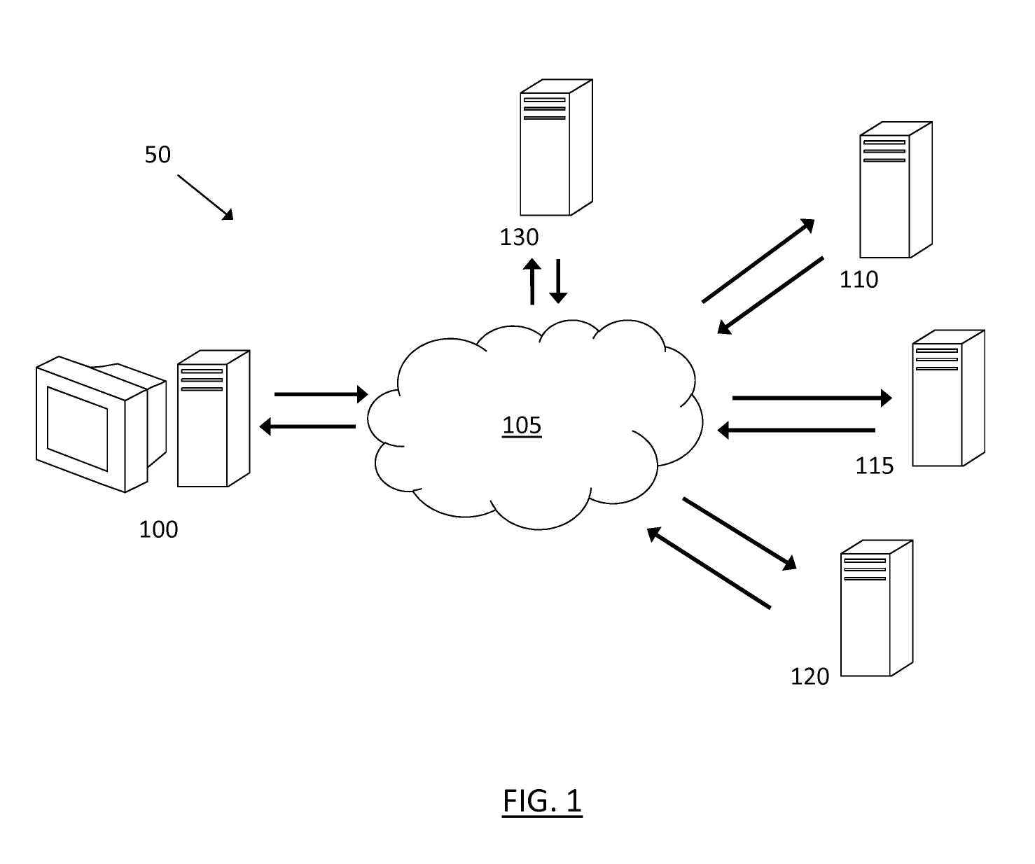

FIG. 1 illustrates an example embodiment of a travel search system 50 implemented in conjunction with various embodiments of the present invention. As shown in FIG. 1, an example embodiment of the travel search system 50 may include a customer interface 100, which may include a personal computer (e.g., a laptop, desktop, or tablet-type computer), a mobile device (e.g., a PDA or cellular/smart phone), a computing kiosk, etc. As illustrated, the customer interface 100 may be in communication with one or more networks, such as network 105. The travel search system of example embodiments may further include one or more airline booking systems 110, hotel booking systems 115, or other travel-related service entities 120, such as ground transportation (train services, bus services, taxi services, rental car services, etc.), water transportation (ferry services, cruise services, etc.), entertainment (ticket brokerages, sports team ticket services, tour operators, etc.). Example embodiments of the travel search system may include a travel booking system 130 that can facilitate travel with any number of providers through a common user interface. The travel booking system 130 may provide a user interface to the customer interface 100 to help the customer book travel by air, land, or water, and to book additional services such as entertainment or lodging.

Example embodiments of the method of determining the taxes and fees for a particular itinerary in an efficient manner may be implemented, for example through travel booking system 130. Each of the components of the system of FIG. 1 may be in electronic communication with, for example, one another over the same or different wireless or wired networks (e.g., network 105) including, for example, a wired or wireless Personal Area Network (PAN), Local Area Network (LAN), Metropolitan Area Network (MAN), Wide Area Network (WAN), or the like. Additionally, while FIG. 1 illustrates the various system entities as separate, standalone entities, the various embodiments are not limited to this particular architecture.

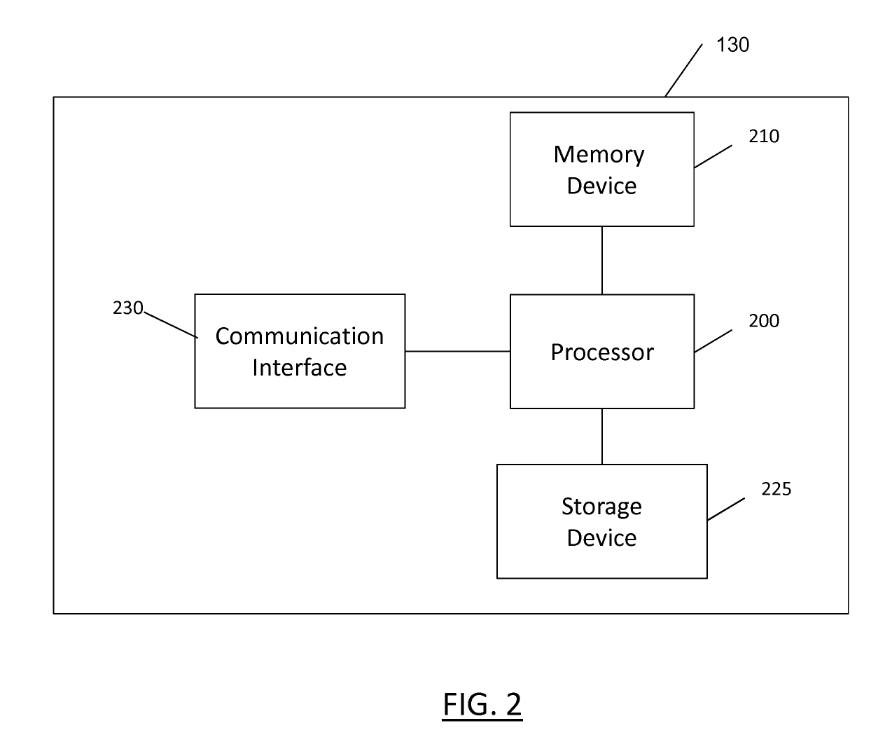

FIG. 2 illustrates the various components of an example embodiment of the travel booking system 130 of FIG. 1. The travel booking system 130 may include a processor 200 that may be embodied in a number of different ways. For example, the processor 200 may be embodied as a processing element, processing circuitry, a coprocessor, a controller or various other processing devices including integrated circuits such as, for example, an application specific integrated circuit (ASIC), a field programmable gate array (FPGA), a hardware accelerator, and/or the like.

In an example embodiment, the processor 200 may be configured to execute instructions stored in a memory (e.g., memory 210) or otherwise accessible to the processor 200. As such, whether configured by hardware or software methods, or by a combination thereof, the processor 200 may represent an entity capable of performing operations according to embodiments of the present invention when configured accordingly. For example, as discussed in more detail below, the travel search system 50, and the travel booking system 130 may be configured, among other things, to facilitate efficient searching for travel itineraries with accurate pricing to improve both a user experience for the customer and a revenue stream for the travel booking system 130.

The memory device 210 may include transitory and non-transitory memory which may include both random access memory (RAM) and read only memory (ROM). The ROM may be used to store a basic input/output system (BIOS) containing the basic routines that help to transfer information to the different elements within the system 130.

The travel booking system 130 may further be in communication with a storage device 225, which may be used as a database for storing itinerary, tax, and fee information, as will be described further below. The storage device may include a hard disk drive, a CD/DVD disk drive, an optical disk drive, solid state drive, or the like, for storing information on various computer-readable media. The storage device(s) 225 and its associated computer-readable media may provide non-volatile storage. The computer-readable media described above could be replaced by any other type of computer-readable media, such as embedded or removable multimedia memory cards (MMCs), secure digital (SD) memory cards, memory sticks, electrically erasable programmable read-only memory (EEPROM), flash memory, hard disk, and/or the like.

Further, a number of executable instructions, applications, scripts, program modules, and/or the like may be stored by the various storage devices 225 and/or within memory device 210. As described in more detail below, these executable instructions, applications, program modules, and/or the like may control certain aspects of the operation of the travel booking system 130 with the assistance of the processor 200 and operating system, although their functionality need not be modularized. In addition to the program modules, the travel booking system 130 may store or be in communication with one or more databases.

The travel booking system 130 may include a communication interface 230 for interfacing with various computing entities and networks. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. The travel booking system 130 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol.

It will be appreciated that one or more components of the travel booking system 130 may be located remotely from other identification system components. For example, the storage device 225 may be located or in communication with a remote network entity. Further, one or more of the components may be combined and additional components performing functions described herein may be included in the travel booking system 130.

The availability of online shopping tools for travel has resulted in frequently changing itinerary prices based on demand and availability that can be dynamically updated by an airline in real time. One of the primary factors in fluctuating itinerary prices, and often one of the most expensive components of an itinerary, is flight prices. The price of a particular flight between two points may fluctuate throughout the course of a week, and often through the course of a day. As such, people shopping for flights may shop around an online market place in an effort to find the lowest cost alternative that suits their specific needs. With numerous websites available to search for airfare itineraries, users may generally gravitate toward a site that can conduct searches for airfare for specific origin and destination airport pairs quickly and efficiently.

A substantial hurdle for travel booking tools are the total costs involved in an itinerary. For example, a hotel may charge a particular rate for a room for a night, but the hotel may also add on a “resort fee” and local sales and tourist taxes. Customers want to be aware of these fees and taxes up front when booking, otherwise they are unpleasantly surprised upon realizing the cost is substantially higher than originally anticipated. For hotels, these fees and taxes are easy to calculate as they are generally fixed fees and tax rates based on the specific hotel and the location of the hotel. Thus it is relatively straight forward to be able to quote a total cost for a hotel room for a night in an itinerary. However, other costs involved in booking itineraries may not be as easily determined.

The total cost of an air-travel itinerary may be more arduous to calculate since air travel involves the cost of the airfare, in addition to taxes and fees for the airfare. However, the taxes and fees can vary based on the origin of the flight, the destination of the flight, and any intervening stops for the flight. While airlines may quote airfare price with certain taxes included (e.g., the excise tax in the US), other taxes and fees may not be included in the quoted airfare. Fees may include per-segment fixed fees, per-departure fixed fees, individual airport “passenger facility charges”, immigration fees, customs fees, governmental surcharges, etc.

The generation of an air-travel itinerary may involve determining flights available between user-selected origin and destination airports, including direct flights, and flights with one or more stops or connections. Each flight or combination of flights may have different fees and taxes associated with it, such that each itinerary must have the fees and taxes calculated individually for the itinerary. For example, a direct flight from New York to San Francisco may incur fees and taxes in a first amount, while a flight from New York to San Francisco by way of Chicago may incur fees and taxes of a second amount. Further, a flight from New York to San Francisco by way of Dallas may incur fees and taxes of a third amount, different from the first or second amount.

The processing resources required to determine an itinerary are relatively low compared to the processing resources required to determine the taxes associated with each itinerary generated for a specific itinerary search. As such, the latency in generating itineraries and their associated costs for a user may be primarily attributed to the tax and fee calculation for each itinerary returned. Latency in providing search results and prices can result in lower customer satisfaction and drive consumers to other resources for searching and purchasing travel. In addition to the latency introduced by the tax and fee calculation for an itinerary, the processing resources required to accomplish this calculation in an efficient manner can heavily burden a travel website. Committing processing resources to tax and fee calculation precludes those resources from being available for other functions, and increases the operational cost to maintain a travel itinerary search and booking engine.

Embodiments of the present invention provide a method of generating taxes and fees for itinerary group of itineraries using a single, representative itinerary from the group. Embodiments may determine a group of itineraries that have similar or common parameters that are determined to have the same taxes and fees associated therewith. A representative itinerary may be used to calculate the taxes and fees that are applicable to each of the itineraries of the group. Systems described herein may then use those calculated taxes and fees in determining the cost of an air-travel itinerary. The taxes and fees calculated for the representative itinerary may be used for each of the itineraries in the group.

Embodiments described herein provide benefits over current methods by reducing the usage of computing resources (e.g., processor 200 processing resources, memory 210 resources, etc.) that are conventionally required to calculate taxes and fees for air-travel itineraries. Further, embodiments enable expedited building of air-travel itineraries. Methods described herein identify itineraries whose taxation results (i.e., the taxes applied to a given itinerary) and fees are identical, such that taxes and fees need to be calculated only for one representative itinerary of such a group and the results can be applied to the other itineraries in the group. When the travel booking system 130 finds a large number of air-travel itineraries connecting origin and destination city, the itineraries often differ only by travel dates and flight numbers. These factors typically don't affect the results of taxation. The ratio of available air-travel itineraries for a specific origin-destination pair (N) to the number of different taxation/fee costs for the origin-destination pair (K) may generally be on the order of between about 10 and 100, based on available connecting flights and the number of reasonable connecting hubs, and the number of different airlines operating the routes.

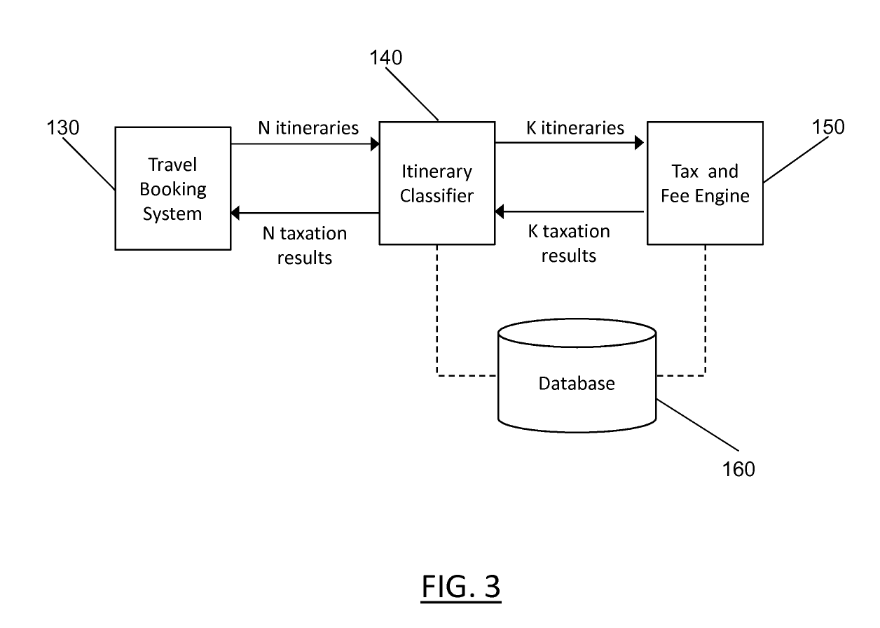

FIG. 3 illustrates an example relationship between the travel booking system 130, the itinerary grouping component 140, and the tax and fee engine 150. While these components are each depicted separately, embodiments may include where the itinerary classifier 140, tax engine 150, and database 160, are each part of the travel booking system 130, such as processor 200 with respect to the itinerary classifier 140 and the tax engine 150 and the storage device 225 with respect to the database 160. The database 160, as will be described further below, may include taxes, fees, geographical, and currency-related data relative to air-travel itineraries.

Embodiments of the present invention may use a grouping algorithm for air-travel itineraries in order to associate them with established taxation/fee costs. The grouping algorithms may be implemented by means of assigning an alphanumeric key to every air-travel itinerary in order to establish an alphanumeric identifier for an itinerary which may be applicable to other itineraries found as part of the same search. All properties that affect taxation and fees may be extracted and included in the alphanumeric key to ensure that the alphanumeric key is unique to the combination of airports, airlines, fare restrictions, etc. of an itinerary.

According to an example embodiment, a first algorithm is established for travel within the US or Canada that may enumerate all airports in the itinerary separating them by a special character. Each airport may be assigned a code by the International Civil Aviation Organization (ICAO). These codes may be four characters; however, airports in the US are often referred to without the common leading character established for the US by the ICAO. Similarly, airports in Canada may be referenced by their three character codes. The alphanumeric key described herein may use the three-character airport code or the four-character airport code as appropriate without deviating from the scope of the invention. The alphanumeric key may further include the code of the carrier providing the service for each leg of the air-travel itinerary. For example, an air-travel itinerary may commence with an origin of Tulsa, Okla. airport (TUL), travel to Dallas-Fort Worth airport (DFW) on an American Airlines flight, and proceed on to a destination of Los Angeles International airport (LAX) on another American Airlines flight. This itinerary may be round-trip, including a flight from Los Angeles International airport to Dallas-Fort Worth and on to Tulsa, Okla., each on an American Airlines flight. The itinerary may be enumerated as TUL-AA-DFW-AA-LAX-AA-DFW-AA-TUL. Non-ticketed points may be included, but should be differentiated from ticketed points. One solution is to prepend the airport code with a chosen character, e.g., hLAS, that may indicate a non-ticketed stopover at McCarran International airport (LAS). Surface segments may also be indicated in the alphanumeric key, such as by a dedicated character or string of characters (e.g., −//−).

In addition to the airports and carriers described above, transfer points and time intervals between flights may be represented. For example, a first character may represent a time interval of zero to four hours between flights, a second character may signify a layover of four hours to twelve hours, and a third character may identify layovers of more than twelve hours. These characters may be concatenated with the aforementioned alphanumeric key. Some taxes or fees may require special consideration in the alphanumeric key as certain fees and taxes may not be collected on certain segments. For example, the AY fee or security fee may require special treatment because it may be waived between a given pair of cities. A character may be used to signify whether the AY fee is to be waived. This may also be concatenated into the alphanumeric key. Fare break and total airfare amount may be included with city codes of fare break locations and the total fare amount. The concatenation of each of these elements may produce the final alphanumeric key used for identifying the air-travel itinerary.

An example embodiment of an alphanumeric key as formed by the algorithm above may include:

MSY-DFW-DIA-DFW-MSY;

where:

### MSY=Louis Armstrong New Orleans International Airport

### DFW=Dallas Fort Worth International Airport

### DIA=Denver International Airport

Additional characters may be concatenated within the alphanumeric key as described above to illustrate the various other aspects of an itinerary that affect the taxes and fees applied to that itinerary.

Another example embodiment may include an algorithm directed toward international travel. The alphanumeric key may be established first through enumeration of all airports in the itinerary separating them by a special character. A carrier code may also be provided for each leg. Non-ticketed points may also be included and may be distinguished from ticketed points, such as by prepending the airport code with a special character as described above. Transfer points may be classified according to the time between the arrival and departure flights as described above; however, unique to international travel, countries may have transfer time limits, and transfer time limits may differ between countries. A list of transit time intervals may be built for each country to be used in the tax and fee rules of the country such that the list of time intervals need not be constructed for every transaction, and would only require updating based on local law or fee rule changes. Similar to the algorithm described above for US/Canada travel, a character may be used to identify layover durations.

According to some embodiments, taxes or fees of certain types may not be applicable to all flights between two cities. For every country, the per carrier ranges of flights that are used in the tax and fee engine 150 may be constructed and stored in database 160. If no special tax and fee rules apply to a segment, the field may be left empty or include a null. Fare break information, total air fare, and total YQ/QR fuel-surcharge fee amounts may be established based on cities and carriers, and may be stored in the database 150. These fare breaks and fees may be represented by one or more characters applied to flight segments in the alphanumeric key.

Taxes and fees may vary depending upon travel date. For each country, a list of date intervals that appear in tax/fee rule records may be generated and stored, such as in database 160, for later use in the calculation of total air-travel itinerary costs. A unique character may be generated for each date interval, and this may be incorporated into the alphanumeric key. Concatenation of each of the aforementioned features of the alphanumeric key may be performed to establish the final alphanumeric key representing an air-travel itinerary. Tax and fee results for itineraries with the same alphanumeric key are identical such that only one itinerary of a given key needs to be processed in tax and fee engine 150.

During calculation of the total cost of an itinerary, the processing resources required to calculate taxes and fees may be drastically reduced, and the latency in providing a priced itinerary to a user may be reduced substantially. Grouping similar itineraries together with identical alphanumeric keys, identifying them all as having the same taxes and fees, enables a single tax and fee calculation to be performed for the entire group. Thus, embodiments described herein may reduce processing resources required for itinerary searching by a factor of 90% or more, thus enabling faster itinerary building and pricing, while reducing the cost to the service provider and freeing up processing resources.

The alphanumeric keys may be used to group together itineraries that are determined to have the same taxes and fees. As the alphanumeric key is configured to incorporate identifiers for each portion of an itinerary that contributes to the taxes and fees associated with the itinerary, itineraries with identical alphanumeric keys may be presumed to have the same taxes and fees associated with them. As such, the itineraries with identical alphanumeric keys may be grouped together such that the taxes and fees need only be calculated for a single, representative itinerary. The taxes and fees established for the representative itinerary may be applied to each of the itineraries in the group, thereby reducing the number of itineraries for which taxes and fees must be calculated by a substantial factor.

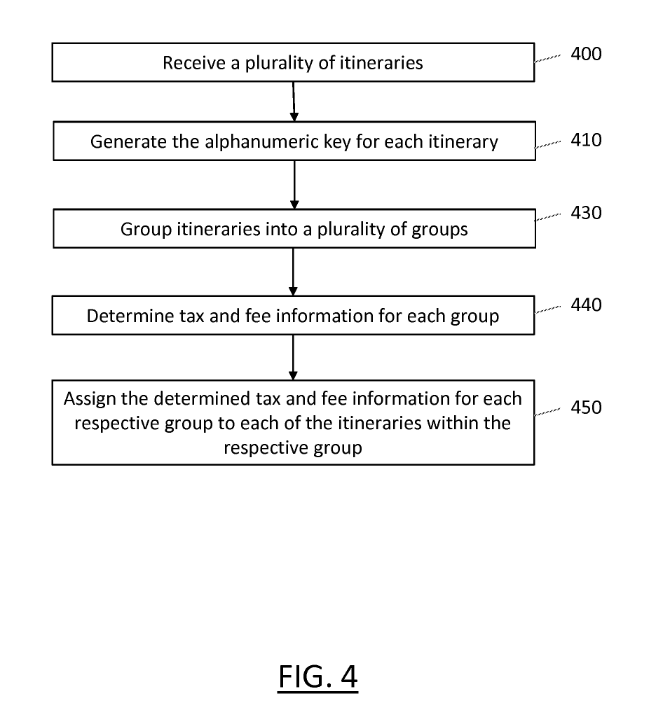

FIG. 4 is a flowchart illustrative of a system, method, and program product according to example embodiments of the invention. The flowchart operations may be performed by a system, such as the travel booking system 130 of FIGS. 1-2, operating over a communications network, such as that shown in FIG. 1, or performed via the travel booking system 130, the itinerary classifier 140, the tax and fee engine 150, and the database 160 of FIG. 3, each of which may be located together with or separate from the travel booking system 130. It will be understood that each block of the flowchart, and combination of blocks in the flowchart, may be implemented by various means, such as hardware, firmware, processor, circuitry, and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware), such as depicted in FIG. 2, to produce a machine, such that the resulting computer or other programmable apparatus embody means for implementing the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

An example embodiment of a method for operating a travel booking system 130 is depicted in the flowchart of FIG. 4. According to the depicted method, a plurality of itineraries may be received at 400. These itineraries may be, for example, the results of a search for itineraries between an origin and a destination. The search may be conducted, for example, at customer interface 100. The travel booking system 130 may determine available itineraries that meet the origin/destination requirements based on flights that are available, as received from airline booking systems 110 of FIG. 1. A key, such as the above-described alphanumeric key may be generated at 410. The alphanumeric key may be generated by the aforementioned algorithms according to flight origin/destination pairs, carrier, stopovers, surcharges, etc. This may be performed in the itinerary classifier 140 of FIG. 3, or alternatively conducted by the processor 200 of the travel booking system 130. The itineraries may be grouped together at 430 into a plurality of groups. This grouping may be performed based on the generated alphanumeric key for each itinerary. Itineraries with matching alphanumeric keys may be grouped together, such as by itinerary classifier 140. The taxes and fees may be determined for each group at 440. According to some embodiments, a representative itinerary may be used from each group to establish the taxes and fees for all of the itineraries in that group. The taxes and fees may be determined at tax and fee engine 150. Once the taxes and fees are determined for a group of itineraries, the determined taxes and fees may be applied to each itinerary within that group at 450.

In an example embodiment, an apparatus for performing the method of FIG. 4 above may comprise a processor (e.g., the processor 200) configured to perform some or each of the operations (400-460) described above. The processor may, for example, be configured to perform the operations (400-460) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-460 may comprise, for example, the processor 200 and/or a device or circuit for executing instructions or executing an algorithm for processing information as described above.

As described above and as will be appreciated by one skilled in the art, embodiments of the present invention may be configured as a system, method or electronic device. Accordingly, embodiments of the present invention may be comprised of various means including entirely of hardware or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An air-travel itinerary search system comprising at least one processor and at least one memory including computer program code, the at least one memory and the computer program code configured to, with the at least one processor, cause an itinerary search system to at least perform:
receive a plurality of itineraries, wherein each itinerary includes an origin and a destination;
determine a key for each of the plurality of itineraries;
group itineraries into a plurality of groups, wherein itineraries with matching keys are grouped together into a single group;
determine tax and fee information for each group; and
assign the determined tax and fee information for each respective group to each of the itineraries within the respective group.

2. The air-travel itinerary search system of claim 1, wherein causing the system to determine tax and fee information for each group comprises causing the system to select a representative itinerary from each group and determine tax and fee information for each selected representative itinerary.

3. The air-travel itinerary search system of claim 2, wherein causing the itinerary search system to group itineraries into a plurality of groups, wherein itineraries with matching keys are grouped together into a single group, may include grouping itineraries that include different travel dates into the same group in response to the keys matching.

4. The air-travel itinerary search system of claim 1, further comprising causing the system to generate a total cost for each of the plurality of itineraries, wherein causing the system to generate a total cost each of the plurality of itineraries comprises causing the system to incorporate the determined tax and fee amount associated with each of the plurality of itineraries with a respective determined variable cost of each of the plurality of itineraries.

5. The air-travel itinerary search system of claim 1, wherein causing the system to determine a key for each of the plurality of itineraries comprises causing the system to:
establish a code associated with the origin airport, the destination airport, and intervening airports, if any, in the air-travel itinerary;
establish a code for at least one fare rule relating to at least one of the origin airport, the destination airport, or an intervening airport; and
concatenate the codes associated with the origin airport, the destination airport, the intervening airport if any, and the code for at least one fare rule relating to at least one of the origin airport, the destination airport, or an intervening airport.

6. The air-travel itinerary search system of claim 5, wherein causing the system to determine a key for each of the plurality of itineraries further comprises causing the system to:
classify a transfer point at an intervening airport according to a layover time;
establish a code for the classified transfer point; and
concatenate the codes associated with the origin airport, the destination airport, the intervening airport, the code for at least one fare rule relating to at least one of the origin airport, the destination airport, or an intervening airport, and the code for the classified transfer point.

7. The air-travel itinerary search system of claim 5, wherein causing the system to determine a key for each of the plurality of itineraries further comprises causing the system to:
determine fare break information associated with any of the origin airport, the destination airport, or the intervening airport if any;
establish a code for the determined fare break information; and
concatenate the codes associated with the origin airport, the destination airport, the intervening airport if any, the code for at least one fare rule relating to at least one of the origin airport, the destination airport, or an intervening airport, and the code for the determined fare break information.

8. A method for determining air-travel itinerary costs comprising:
receiving a plurality of itineraries, wherein each itinerary includes an origin and a destination;
determining a key for each of the plurality of itineraries;
grouping itineraries into a plurality of groups, wherein itineraries with matching keys are grouped together into a single group;
determining tax and fee information for each group; and
assigning the determined tax and fee information for each respective group to each of the itineraries within the respective group.

9. The method of claim 8, wherein determining tax and fee information for each group comprises selecting a representative itinerary from each group and determining tax and fee information for each selected representative itinerary.

10. The method of claim 9, wherein grouping itineraries into a plurality of groups, wherein itineraries with matching keys are grouped together into a single group, may include grouping itineraries that include different travel dates into the same group in response to the keys matching.

11. The method of claim 8, further comprising generating a total cost for each of the plurality of itineraries, wherein generating a total cost each of the plurality of itineraries comprises incorporating the determined tax and fee information associated each of the plurality of itineraries with a respective determined variable cost of each of the plurality of itineraries.

12. The method of claim 8, wherein determining a key for each of the plurality of itineraries comprises:
establishing a code associated with the origin airport, the destination airport, and intervening airports, if any, in the itinerary;
establishing a code for at least one fare rule relating to at least one of the origin airport, the destination airport, or an intervening airport; and
concatenating the codes associated with the origin airport, the destination airport, the intervening airport if any, and the code for at least one fare rule relating to at least one of the origin airport, the destination airport, or an intervening airport.

13. The method of claim 12, wherein determining a key for each of the plurality of itineraries further comprises:
classifying a transfer point at an intervening airport according to a layover time;
establishing a code for the classified transfer point; and
concatenating the codes associated with the origin airport, the destination airport, the intervening airport, the code for at least one fare rule relating to at least one of the origin airport, the destination airport, or an intervening airport, and the code for the classified transfer point.

14. The method of claim 12, wherein determining a key for each of the plurality of itineraries further comprises:
determining fare break information associated with any of the origin airport, the destination airport, or the intervening airport if any;
establishing a code for the determined fare break information; and
concatenating the codes associated with the origin airport, the destination airport, the intervening airport if any, the code for at least one fare rule relating to at least one of the origin airport, the destination airport, or an intervening airport, and the code for the determined fare break information.

15. A computer program product comprising at least one non-transitory computer-readable storage medium having computer-readable program instructions stored therein, the computer-readable program instructions comprising:
program code instructions for receiving a plurality of itineraries, wherein each itinerary includes an origin and a destination;
program code instructions for determining a key for each of the plurality of itineraries;
program code instructions for grouping itineraries into a plurality of groups, wherein itineraries with matching keys are grouped together into a single group;
program code instructions for determining tax and fee information for each group; and
program code instructions for assigning the determined tax and fee information for each respective group to each of the itineraries within the respective group.

16. The computer program product of claim 15, wherein the program code instructions for determining tax and fee information for each group comprises program code instructions for selecting a representative itinerary from each group and program code instructions for determining tax and fee information for each selected representative itinerary.

17. The computer program product of claim 16, wherein itineraries with matching keys may include itineraries that include different travel dates into the same group in response to the keys matching.

18. The computer program product of claim 15, further comprising program code instructions for generating a total cost for each of the plurality of itineraries, wherein the program code instructions for generating a total cost each of the plurality of itineraries comprises program code instructions for incorporating the determined tax and fee amount associated each of the plurality of itineraries with a respective determined variable cost of each of the plurality of itineraries.

19. The computer program product of claim 15, wherein the program code instructions for determining a key for each of the plurality of itineraries comprises:
program code instructions for establishing a code associated with the origin airport, the destination airport, and intervening airports, if any, in the air-travel itinerary;
program code instructions for establishing a code for at least one fare rule relating to at least one of the origin airport, the destination airport, or an intervening airport; and
program code instructions for concatenating the codes associated with the origin airport, the destination airport, the intervening airport if any, and the code for at least one fare rule relating to at least one of the origin airport, the destination airport, or an intervening airport.

20. The computer program product of claim 16, wherein the program code instructions for determining a key for each of the plurality of itineraries further comprises:
program code instructions for classifying a transfer point at an intervening airport according to a layover time;
program code instructions for establishing a code for the classified transfer point; and
program code instructions for concatenating the codes associated with the origin airport, the destination airport, the intervening airport, the code for at least one fare rule relating to at least one of the origin airport, the destination airport, or an intervening airport, and the code for the classified transfer point.
